(19) United States
(12) Patent Application Publication
(10) Pub. No.: US 2026/0128521 A1
(43) Pub. Date: May 7, 2026

(54) COMMUNICATION APPARATUS AND CONTROL METHOD OF COMMUNICATION APPARATUS

(71) Applicant: Yoshikawakogyo RF Semicon Co., Ltd., Koyu-gun (JP)

(72) Inventor: Shigeru ARISAWA, Koyu-gun (JP)

(21) Appl. No.: 19/372,105

(22) Filed: Oct. 28, 2025

(30) Foreign Application Priority Data
Nov. 5, 2024 (JP) 2024-193775

(51) Int. Cl. H01Q 7/00; H04B 1/52

(52) U.S. Cl. CPC H01Q 7/00; H04B 1/52

(57) ABSTRACT

A communication apparatus configured to communicate with a wireless tag, includes: a plurality of loop antennas, each of the antennas being configured to output a magnetic field corresponding to a transmission signal relating to the communication with the wireless tag to independently communicate with the wireless tag; a communication control unit configured to output the transmission signal to a communication-target loop antenna among the plurality of loop antennas; and a control unit configured to control a non-target loop antenna different from the communication-target loop antenna to generate a magnetic field for negating a magnetic field leaking from the communication-target loop antenna.

### CROSS-REFERENCE TO RELATED APPLICATIONS

This application is based upon and claims the benefit of priority of the prior Japanese Patent Application No. 2024-193775, filed on Nov. 5, 2024, the entire contents of which are incorporated herein by reference.

### BACKGROUND OF THE INVENTION

### Field of the Invention

The present invention relates to a communication apparatus configured to communicate with a wireless tag and a control method thereof.

### Description of the Related Art

A reader and reader/writer conforming to the ISO 15693 standard uses a frequency band such as the high frequency (HF) band, and reads and writes data to a wireless tag such as a radio frequency identification (RFID) tag or an RFID card. Hereinafter, such a reader and a reader/writer are collectively referred to as a reader/writer without distinction. The reader/writer is configured to read and/or write data to the wireless tag in a non-contact manner by coupling a loop antenna provided in the reader/writer and a loop antenna provided in the wireless tag.

For example, the reader/writer puts information, such as a read command of the wireless tag, onto a high-frequency carrier signal (carrier wave) by using a predetermined modulation method and outputs it as a magnetic field from the loop antenna. The wireless tag uses the electromagnetic induction of its mounted loop antenna to capture the magnetic field generated by the reader/writer as an electrical signal for its operating power. The wireless tag also decodes the read command contained in the captured electrical signal, and according to the decoding result, returns data stored in an internal memory to the reader/writer with a load switch or other means. The reader/writer then receives the returned signal from the wireless tag via the loop antenna and decodes the signal to read the data.

As illustrated in FIG. 11A, a reader/writer is proposed that includes a plurality of loop antennas and reads and/or writes data from/to a wireless tag through the respective loop antennas. The reader/writer with a plurality of loop antennas includes a control unit 1110 for communication-related control, an antenna unit 1120 including the loop antennas 1121 and matching circuits 1122, and a switching circuit provided between the control unit 1110 and the antenna unit 1120. The switching circuit is configured to select a loop antenna 1121 as communication target, and the reading/writing of data is performed for a wireless tag 1123 arranged for the target loop antenna 1121.

For such a reader/writer with a plurality of loop antennas, the spacing between antennas needs to be narrowed to reduce the overall area occupied by the loop antennas. However, the narrowed spacing between loop antennas may result in unintended writing or reading of data to/from a wireless tag arranged for a loop antenna that is adjacent to the target loop antenna, which may make it impossible to independent reading or writing of a wireless tag arranged for each loop antenna. This is because, as illustrated in FIG. 11B, a magnetic field 1142 generated by the target loop antenna 1141 may leak outside from the loop antenna 1141 and may cause reading or writing of data to the wireless tag arranged for the adjacent loop antenna 1143.

As one solution to such a situation, Patent Document 1 proposes a technique to prevent unintended reading of an RF tag that is close to an RF tag on a specimen container adjacent to a reading target. Patent Document 2 proposes a technique to appropriately control a reading antenna configured to read an RFID tag and a read-restriction antenna configured to restrict an RFID tag from being read by another adjacent reading antenna to prevent unintended reading of the RFID tag arranged for the adjacent antenna.

However, the technique proposed by Patent Document 1 only includes one reading antenna in the system and is not applicable to a reader/writer with a plurality of antennas. Additionally, providing the read-restriction antenna for read restriction as described in Patent Document 2 is not preferable because it results in a more complicated antenna structure.

Other solutions may include installing a shield plate between the target loop antenna and the adjacent loop antenna, or generating an interference signal from the adjacent loop antenna. To reduce the leakage field with the shield plate between the loop antennas, it is necessary to place the shield plate as close as possible to the loop antennas, and to ensure an appropriate length of the shield plate. However, these requirements may result in the loss of the intensity of the magnetic field that is inherently involved in reading and writing, and therefore the shield plate cannot be an appropriate solution. Alternatively, to reduce the leakage field by generating an interference signal from the adjacent loop antenna, it is necessary to generate an interference signal of sufficient level. However, such an interference signal may unintentionally reach the target loop antenna, which may degrade communication quality.

As described above, it has been difficult to prevent unintended reading of a wireless tag arranged for an adjacent loop antenna due to a leakage field by using the above-described techniques. When a plurality of wireless tags are arranged for a communication-target loop antenna, reading the wireless tags in parallel requires the target loop antenna to generate a high intensity of magnetic field. Thus, it is difficult to prevent unintended reading of the wireless tag arranged for the adjacent loop antenna.
Patent Document 1: Japanese Laid-open Patent Publication No. 2011-075360
Patent Document 2: Japanese Laid-open Patent Publication No. 2021-049331

### SUMMARY OF THE INVENTION

An object of the present invention is to provide a communication apparatus and a control method thereof that can prevent unintended reading of a wireless tag other than a communication target without providing a read restriction antenna or the like.

A communication apparatus according to the present invention is a communication apparatus configured to communicate with a wireless tag, including: a plurality of loop antennas, each of the antennas being configured to output a magnetic field corresponding to a transmission signal relating to the communication with the wireless tag to independently communicate with the wireless tag; a communication control unit configured to output the transmission signal to a communication-target loop antenna among the plurality of loop antennas; and a control unit configured to control a non-target loop antenna different from the communication-target loop antenna to generate a magnetic field for negating a leakage magnetic field from the communication-target loop antenna.

According to the present invention, a communication apparatus and a control method thereof that can prevent unintended reading of a wireless tag other than a communication target without providing a read restriction antenna or the like can be provided.

### BRIEF DESCRIPTION OF THE DRAWINGS

FIG. 1 is a view explaining the prevention of unintended reading of a wireless tag in this embodiment.

FIG. 2 is a diagram illustrating a configuration example of a communication apparatus in a first embodiment.

FIG. 3 is a diagram illustrating a configuration example of a level adjustment circuit.

FIG. 4 is a view explaining the prevention of unintended reading of a wireless tag by the communication apparatus in the first embodiment.

FIG. 5 is a diagram illustrating another configuration example of the communication apparatus in the first embodiment.

FIG. 6 is a diagram illustrating a configuration example of a communication apparatus in a second embodiment.

FIG. 7 is a diagram illustrating a configuration example of an unintended-reading prevention circuit.

FIG. 8 is a view explaining the prevention of unintended reading of a wireless tag by the communication apparatus in the second embodiment.

FIG. 9A is a diagram illustrating an example of electrical circuit models of loop antennas.

FIG. 9B is a schematic diagram illustrating an example of signal waveforms at loop antennas.

FIG. 9C is a diagram illustrating an example of the relation between values of a capacitance and the current flowing in an inductance.

FIG. 10 is a diagram illustrating an example of a relation between the resonance frequency of an adjacent loop antenna and the operating voltage obtained by a wireless tag.

FIG. 11A is a view explaining a reader/writer with a plurality of loop antennas.

FIG. 11B is a view explaining unintended reading of a wireless tag by a reader/writer with a plurality of loop antennas.

### DETAILED DESCRIPTION OF THE PREFERRED EMBODIMENTS

Embodiments of the present invention are described with reference to the drawings.

In the following description, a wireless tag arranged in a defined read/write area of a loop antenna, i.e., a wireless tag arranged for reading/writing of data by the loop antenna, may be referred to as “a wireless tag arranged for a loop antenna”.

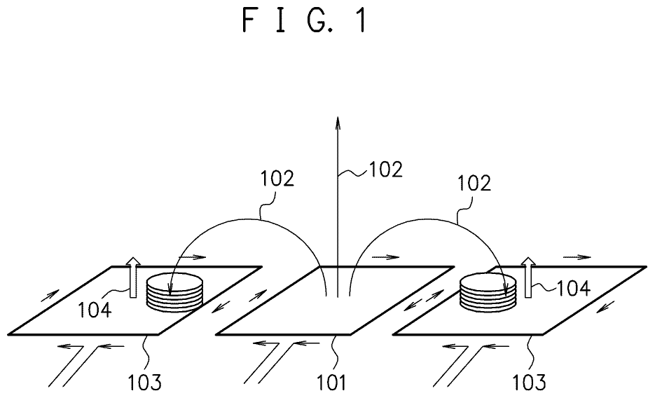

As illustrated in FIG. 1, to prevent unintended reading of a wireless tag arranged for a loop antenna 103 adjacent to a communication-target loop antenna 101 due to a leakage magnetic field 102 from the target loop antenna 101 without widening the spacing between the antennas, the adjacent loop antenna 103 can be configured to generate a magnetic field 104 of the same direction as that of the target loop antenna 101 to negate the leakage magnetic flux. In each of the embodiments described below, the unintended reading of the wireless tag arranged for the adjacent loop antenna 103 can be prevented by causing the adjacent loop antenna 103 to generate such a magnetic field 104. Such a magnetic field 104 can be generated by supplying a current of the same direction and phase as the target loop antenna 101 to the adjacent loop antenna 103. In FIG. 1, the arrows illustrated around the loop antennas indicate the direction of the current flowing the loop antennas (the same applies below).

### First Embodiment

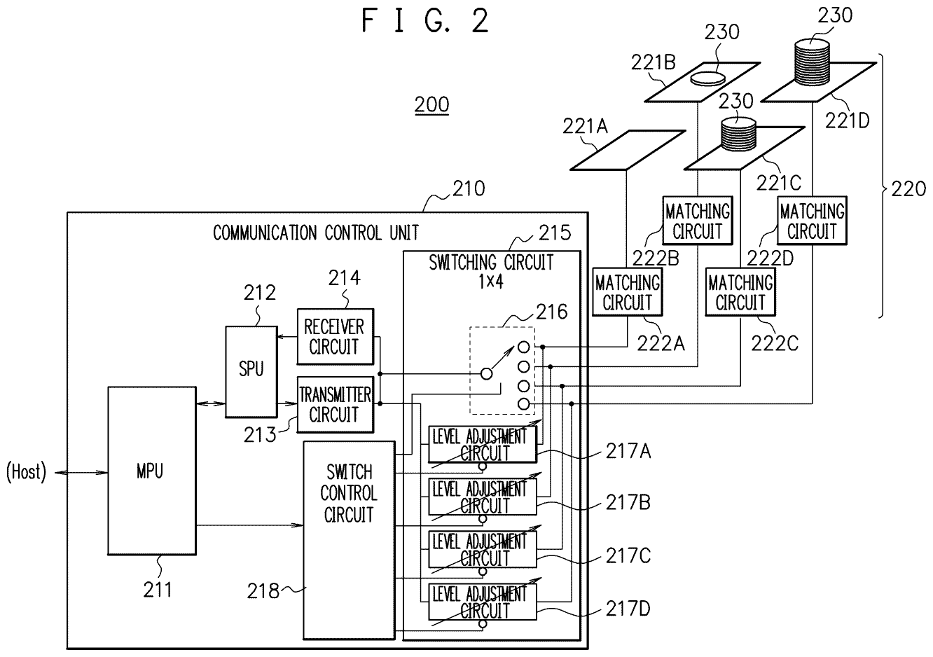

FIG. 2 is a diagram illustrating a configuration example of a reader/writer 200 as a communication apparatus in a first embodiment. The reader/writer 200 is a reader/writer including a plurality of loop antennas 221 (a multi-antenna reader/writer). The reader/writer 200 is configured to communicate with a wireless tag 230, such as a radio frequency identification (RFID) tag or an RFID card, via the respective loop antennas 221 to read and/or write data from/to the wireless tag 230. The reader/writer 200 includes a communication control unit 210 and an antenna unit 220. The communication control unit 210 and the antenna unit 220 are connected to each other via a connector such as an SMA connector.

The communication control unit 210 is configured to perform various control processes for communicating with the wireless tag 230. For example, the communication control unit 210 is configured to transmit a transmission signal to the wireless tag 230 that contains information such as a processing command (e.g., read command and/or write command) of the wireless tag and receive a reception signal relating to a response from the wireless tag 230 to the transmission signal. The communication control unit 210 includes a microprocessor (MPU) 211, a signal processing unit (SPU) 212, a transmitter circuit 213, a receiver circuit 214, a switching circuit 215, and a switch control circuit 218. While the example in FIG. 2 illustrates a configuration of communication processing at the communication control unit 210, the communication control unit 210 may include other components such as a power supply circuit.

The MPU 211 is configured to integrally control the reader/writer 200 (the communication control unit 210). The signal processing unit 212 is configured to perform signal processing of signals transmitted/received to/from the wireless tag 230 via the loop antenna 221. The transmitter circuit 213 is configured to modulate a signal processed by the signal processing unit 212 in accordance with a predetermined modulation method to generate and output a transmission signal. The generated transmission signal is provided to the wireless tag 230 via the loop antenna 221. The receiver circuit 214 is configured to demodulate a signal received from the wireless tag 230 via the loop antenna 221 in accordance with a modulation method and output the demodulated signal to the signal processing unit 212.

The switching circuit 215 is a switching circuit for selecting a loop antenna 221 as a communication target. The switching circuit 215 is also configured to provide a signal for generating a magnetic field that can negate a leakage magnetic field from the target loop antenna 221 (i.e., a magnetic field in a direction opposite to the leakage magnetic field), to other loop antennas (non-target loop antennas) 221 that are different from the target loop antenna 221. The switching circuit 215 includes a selection circuit 216 and level adjustment circuits 217A to 217D.

For example, the selection circuit 216 can be implemented with a 1:N (N is the number of loop antennas 221) switch and configured to alternatively select a communication-target loop antenna 221 from among a plurality of loop antennas 221A to 221D. In other words, the selection circuit 216 is configured to control the connection of the transmitter circuit 213 and the receiver circuit 214 to the loop antennas 221A to 221D such that signals can be transmitted/received to/from the target loop antenna 221. For example, when the loop antenna 221A is the target loop antenna, the selection circuit 216 is configured to communicably connect the transmitter circuit 213 and the receiver circuit 214 to the loop antenna 221A. Similarly, when the loop antenna 221B is the target loop antenna, the selection circuit 216 is configured to communicably connect the transmitter circuit 213 and the receiver circuit 214 to the loop antenna 221B. The control is similar when the target loop antenna is the loop antenna 221C or the loop antenna 221D.

The level adjustment circuits 217A to 217D are configured to adjust the level of a signal that is transmitted to a loop antenna 221 different from the target loop antenna 221 for causing the loop antenna 221 to generate a magnetic field for negating the leakage magnetic field from the target loop antenna 221. In this example, the level adjustment circuits 217A to 217D are configured to adjust the current level of a transmission signal (modulated wave) transmitted to the target loop antenna 221 for output to the loop antennas 221A to 221D. At the level adjustment circuit 217 corresponding to the target loop antenna 221, the output is set to a high-impedance (Hi-Z) state, and no signal is output.

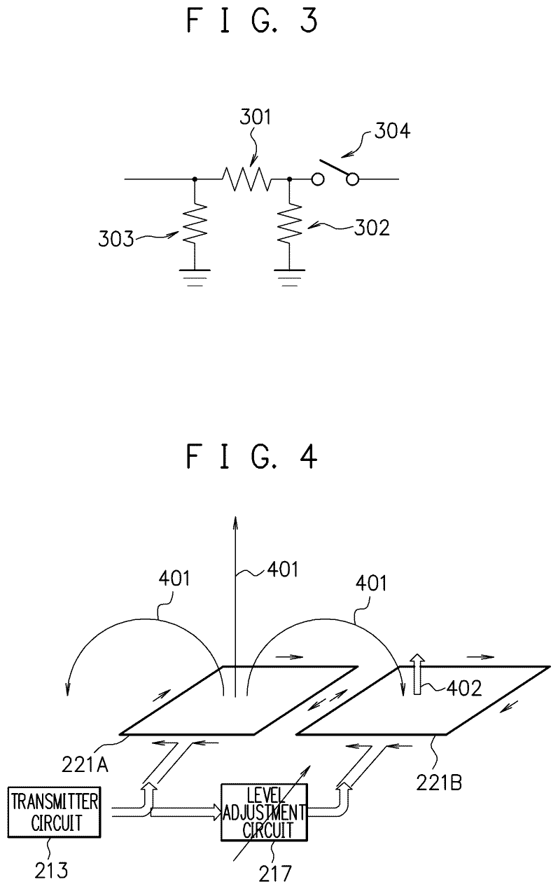

FIG. 3 is a diagram illustrating an example of the level adjustment circuits 217A to 217D. For example, as illustrated in FIG. 3, the level adjustment circuits 217A to 217D may be variable attenuators in which resistors 301 to 303 and a switch 304 are connected, and are configured to attenuate the current level of an input signal for output. The amount of level adjustment in the level adjustment circuits 217A to 217D can be changed by selecting an appropriate resistance value for the resistors 301 to 303. In the level adjustment circuit 217 corresponding to the target loop antenna 221, the switch 304 is controlled to be in the off (open, non-conducting) state; and in the level adjustment circuits 217 corresponding to the other loop antennas 221, the switch 304 is controlled to be in the on (closed, conducting) state to output a signal with attenuated current level. The level adjustment circuits 217A to 217D illustrated in FIG. 3 are merely illustrative and are not limiting. The level adjustment circuits 217A to 217D may be variable output amplifiers, for example.

The switch control circuit 218 is configured to control the selection circuit 216 and the level adjustment circuits 217A to 217D, which are included in the switching circuit 215, based on the control by the MPU 211. The switch control circuit 218 is configured to control the connection state at the selection circuit 216 and the amount of adjustment by the level adjustment circuits 217A to 217D, depending on the target loop antenna 221.

The antenna unit 220 includes the loop antennas 221A to 221D and matching circuits 222A to 222D. The loop antennas 221A to 221D are configured to output a magnetic field in response to a transmission signal supplied thereto and communicate with the wireless tag 230 arranged therefor to exchange signals relating to the reading and writing of data with the wireless tag 230. Each of the loop antennas 221A to 221D can independently communicate with the wireless tag 230. The matching circuits 222A to 222D are configured for impedance matching.

A method of preventing unintended reading of the wireless tag by the reader/writer 200 in the first embodiment is described with reference to FIG. 4. FIG. 4 illustrates an example where the target loop antenna is the loop antenna 221A, and the adjacent loop antenna is the loop antenna 221B in the configuration illustrated in FIG. 2. The transmitter circuit 213 is configured to output a transmission signal (modulated wave) modulated with a command to the wireless tag; the output transmission signal is provided to the target loop antenna 221A, and the target loop antenna 221A can generate a magnetic field 401 in response to the transmission signal. At this time, applying a transmission signal (modulated wave) of the same phase to the adjacent loop antenna 221B can generate a magnetic field of the same phase as that of the target loop antenna 221A. The current level of the transmission signal (modulated wave) supplied to the adjacent loop antenna 221B is adjusted by the level adjustment circuit 217, and thus the adjacent loop antenna 221B generates a magnetic field 402 of an appropriate intensity, thereby negating a magnetic field leaking from the target loop antenna 221A to the adjacent loop antenna 221B. As described above, negating the leakage magnetic field from the target loop antenna can prevent unintended reading of the wireless tag arranged for the adjacent loop antenna.

The reader/writer 200 illustrated in FIG. 2 can supply the transmission signal (modulated wave) output from the transmitter circuit 213 to the target loop antenna 221 and can also supply the transmission signal (modulated wave) output from the transmitter circuit 213 via the level adjustment circuit 217 to the respective non-target loop antennas 221.

The reader/writer 200 is configured to select, as a communication-target loop antenna, the loop antenna 221 for which a targeted wireless tag 230 for reading and writing of data is arranged, and perform the reading and writing of data to the wireless tag 230 arranged for the selected loop antenna 221. The reader/writer 200 is also configured to supply a transmission signal with a level adjusted by the level adjustment circuit 217 to a non-selected loop antenna 221. For example, when the switching circuit 215 selects the loop antenna 221A as the target loop antenna, the transmission signals with levels adjusted by the level adjustment circuits 217B, 217C, 217D are supplied to the other loop antennas 221B, 221C, 221D. The adjustment levels of each of the level adjustment circuits 217 can be preadjusted such that a magnetic field of the same intensity as a leakage magnetic field leaking outside from the target loop antenna 221 can be generated.

Thus, with the reader/writer 200 in the first embodiment, a loop antenna adjacent to a communication-target loop antenna can generate a magnetic field of the same intensity as a leakage magnetic field leaking from the target loop antenna to negate the leakage magnetic field from the target loop antenna, and thus unintended reading of a wireless tag arranged for the adjacent loop antenna can be prevented. Even if the intensity of the magnetic field output by the target loop antenna is increased, the adjacent loop antenna can negate the leakage magnetic field from the target loop antenna. Thus, the unintended reading of the wireless tag arranged for the adjacent loop antenna can be prevented while it is possible to read many wireless tags in parallel.

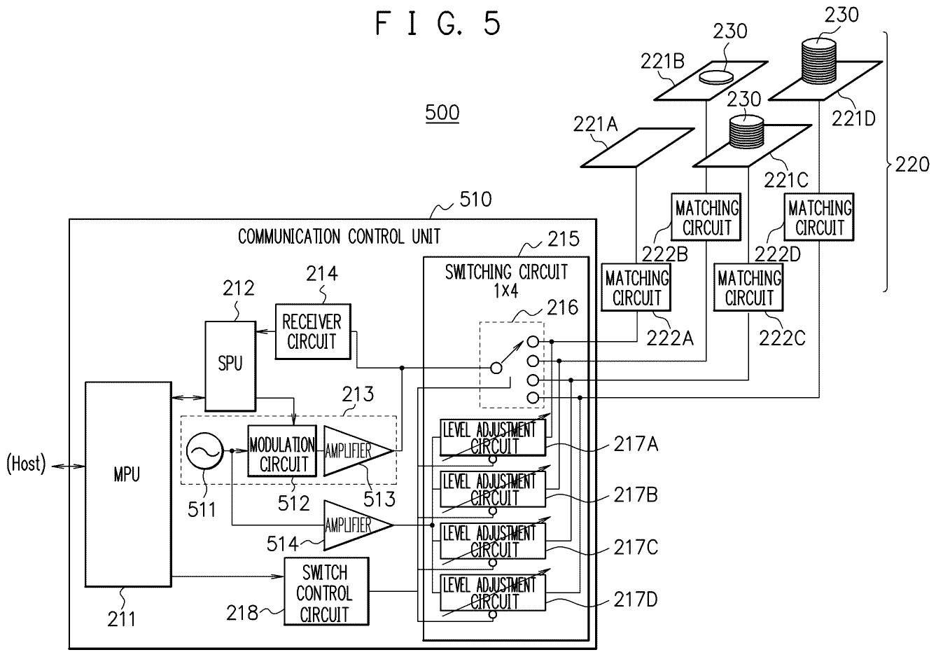

While a modulated transmission signal (modulated wave) is supplied to the adjacent loop antenna in the previous example, an unmodulated carrier signal (carrier wave) may be supplied. FIG. 5 illustrates a configuration example where a carrier signal (carrier wave) is supplied to the adjacent loop antenna. FIG. 5 is a diagram illustrating another configuration example of the reader/writer as the communication apparatus in the first embodiment. In FIG. 5, components having the same functions as those illustrated in FIG. 2 are denoted by the same reference numerals and symbols, and redundant explanations are omitted.

The reader/writer 500 in FIG. 5 includes a communication control unit 510 and an antenna unit 220. The communication control unit 510 corresponds to the communication control unit 210 in FIG. 2. The communication control unit 510 includes the MPU 211, the signal processing unit (SPU) 212, the transmitter circuit 213, the receiver circuit 214, the switching circuit 215, the switch control circuit 218, and an amplifier 514.

The transmitter circuit 213 is a specific example of the transmitter circuit in FIG. 2, and includes an oscillator 511, a modulation circuit 512, and an amplifier 513. The oscillator 511 is configured to generate a carrier signal (carrier wave). The carrier generated by the oscillator 511 is modulated by the modulation circuit 512 with a transmission signal from the signal processing unit 212 to generate a modulated wave. The modulated wave is output by the amplifier 513 and the switching circuit 215. The carrier wave generated by the oscillator 511 is also amplified by the amplifier 514, and then the level of the carrier wave is adjusted by the level adjustment circuits 217A to 217D of the switching circuit 215 to be output to the loop antennas 221A to 221D. The control processes for the selection circuit 216 and the level adjustment circuits 217A to 217D of the switching circuit 215 are the same as in the previous example.

Thus, even in a case where an unmodulated carrier signal (carrier wave) is supplied to the adjacent loop antenna, the adjacent loop antenna can generate a magnetic field of the same phase as the magnetic field generated by the target loop antenna. Accordingly, similarly to the previous example, a loop antenna adjacent to a communication-target loop antenna can generate a magnetic field of the same intensity as a leakage magnetic field leaking from the target loop antenna to negate the leakage magnetic field from the target loop antenna, and thus unintended reading of a wireless tag arranged for the adjacent loop antenna can be prevented.

In the example illustrated in FIG. 2, the transmitter circuit 213 and the receiver circuit 214 are connected to the target loop antenna 221 via the selection circuit 216 of the switching circuit 215. However, only the receiver circuit 214 may be connected to the target loop antenna 221 via the selection circuit 216 of the switching circuit 215, and the transmitter circuit 213 may be connected to the loop antenna 221 via the level adjustment circuit 217. In this case, the level adjustment circuit 217 corresponding to the target loop antenna 221 may output the transmission signal (modulated wave) from the transmitter circuit 213 without level adjustment; and the level adjustment circuit 217 corresponding to the non-target loop antenna 221 may adjust the level of the transmission signal (modulated wave) from the transmitter circuit 213 for output.

### Second Embodiment

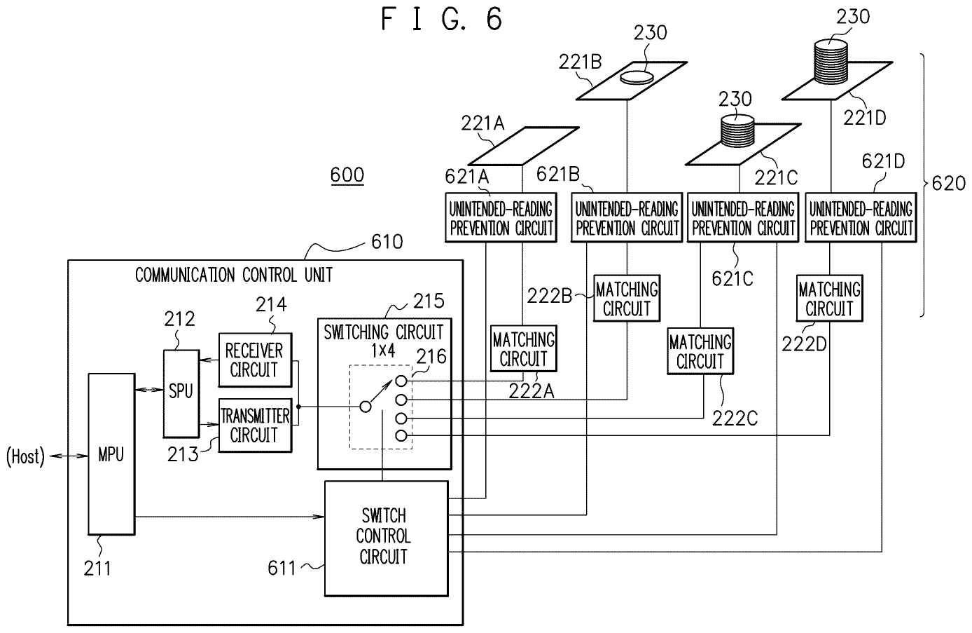

FIG. 6 is a diagram illustrating a configuration example of a reader/writer 600 as a communication apparatus in a second embodiment. In FIG. 6, components having the same functions as those illustrated in FIG. 2 are denoted by the same reference numerals and symbols, and redundant explanations are omitted. The reader/writer 600 is a reader/writer including a plurality of loop antennas 221 (a multi-antenna reader/writer). The reader/writer 600 is configured to communicate with a wireless tag 230, such as an RFID tag or an RFID card, via the respective loop antennas 221 to read and/or write data from/to the wireless tag 230. The reader/writer 600 includes a communication control unit 610 and an antenna unit 620. The communication control unit 610 and the antenna unit 620 are connected to each other via a connector such as an SMA connector.

The communication control unit 610 is configured to perform various control processes for communicating with the wireless tag 230, similarly to the communication control unit 210 in FIG. 2. The communication control unit 610 includes MPU 211, the signal processing unit (SPU) 212, the transmitter circuit 213, the receiver circuit 214, the switching circuit 215, and a switch control circuit 611.

The switching circuit 215 is configured to select a loop antenna 221 as a communication target. In contrast to the first embodiment, the switching circuit 215 includes a selection circuit 216, but does not include the level adjustment circuits 217A to 217D. The switch control circuit 611 is configured to control the selection circuit 216, which are included in the switching circuit 215, and unintended-reading prevention circuits 621A to 621D described below based on the control by the MPU 211. The switch control circuit 218 is configured to control the connection state of switches of the selection circuit 216 and the unintended-reading prevention circuits 621A to 621D, depending on the target loop antenna 221.

The antenna unit 620 includes the loop antennas 221A to 221D and the matching circuits 222A to 222D as well as the unintended-reading prevention circuits 621A to 621D. The unintended-reading prevention circuits 621A to 621D are connected between the corresponding loop antennas 221A to 221D and the matching circuits 222A to 222D, respectively. The unintended-reading prevention circuits 621A to 621D have a capacitance (capacitor) and are configured to control the resonance frequency (tuning frequency) of a circuit that includes the loop antenna and the capacitance. When the connected loop antenna 221 is not the target loop antenna, the unintended-reading prevention circuits 621A to 621D are configured to control the resonance frequency (tuning frequency) of the circuit that includes the loop antenna and the capacitance to be tuned to a frequency lower than that of the carrier signal (carrier wave).

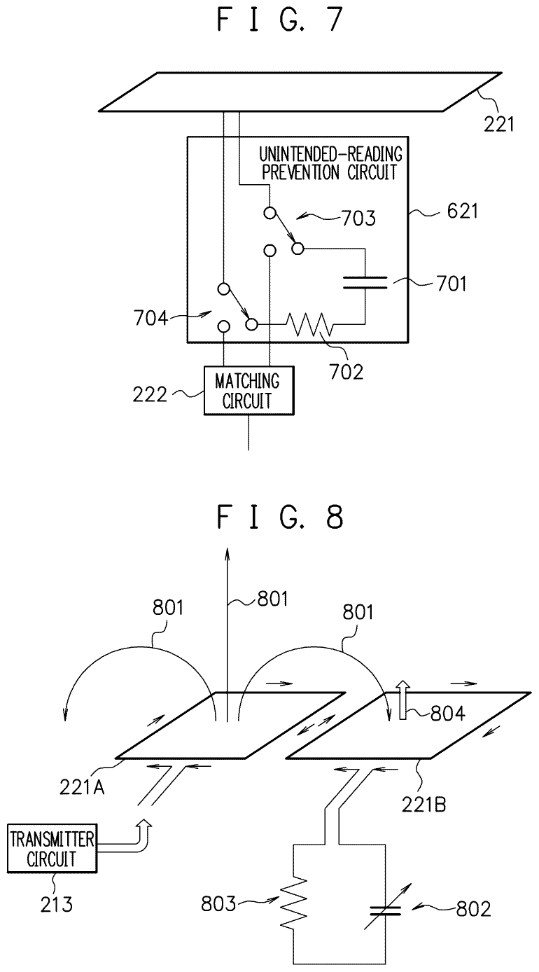

FIG. 7 is a diagram illustrating a configuration example of the unintended-reading prevention circuits 621A to 621D. For example, as illustrated in FIG. 7, the unintended-reading prevention circuits 621A to 621D each include a capacitance (capacitor) 701 and a resistor 702 that are connected in series, and also include two switches 703, 704. The switches 703, 704 are configured to switch the connection to the loop antenna 221 between the matching circuit 222 and the series circuit of the capacitance (capacitor) 701 and the resistor 702. Specifically, when the corresponding loop antenna 221 is the target loop antenna, the switches 703, 704 are controlled to connect the loop antenna 221 and the matching circuit 222. When the corresponding loop antenna 221 is not the target loop antenna, the switches 703, 704 are controlled to connect the loop antenna 221 and the serial circuit of the capacitance (capacitor) 701 and the resistor 702. In other words, when the corresponding loop antenna 221 is not the target loop antenna, the loop antenna 221 will form a so-called series LCR circuit with the capacitance (capacitor) 701 and the resistor 702 of the unintended-reading prevention circuit 621. If the resistance value required for the resistor 702 is sufficiently small, the resistor 702 may be omitted, and such a resistance may be realized by a parasitic component.

A method of preventing unintended reading of the wireless tag by the reader/writer 600 in the second embodiment is described with reference to FIG. 8. FIG. 8 illustrates an example where the target loop antenna is the loop antenna 221A, and the adjacent loop antenna is the loop antenna 221B in the configuration illustrated in FIG. 6. The transmission signal (modulated wave) output by the transmitter circuit 213 is provided to the target loop antenna 221A, and the target loop antenna 221A generates a magnetic field 801 in response to the transmission signal. The magnetic field 801 generated by the target loop antenna 221A may leak outside from the target loop antenna 221A to generate the interlinkage with the adjacent loop antenna 221B. As a result, electromagnetic induction may generate a voltage at the adjacent loop antenna 221B, and current may flow through the adjacent loop antenna 221B with the capacitance 802 and the resistor 803 that are connected in series in the unintended-reading prevention circuit 621B. At this time, by tuning the resonance frequency of the circuit including the loop antenna 221B and the capacitance 802 to a frequency lower than that of the carrier signal (carrier wave), a signal having the same phase as the transmission signal (modulated wave) supplied to the target loop antenna 221A can be generated for the adjacent loop antenna 221B. The adjacent loop antenna 221B generates a magnetic field 804 with this signal having the same phase as that of the transmission signal (modulated wave) to negate the leakage magnetic field 801 from the target loop antenna 221A, and thus the unintended reading of the wireless tag arranged for the adjacent loop antenna can be prevented.

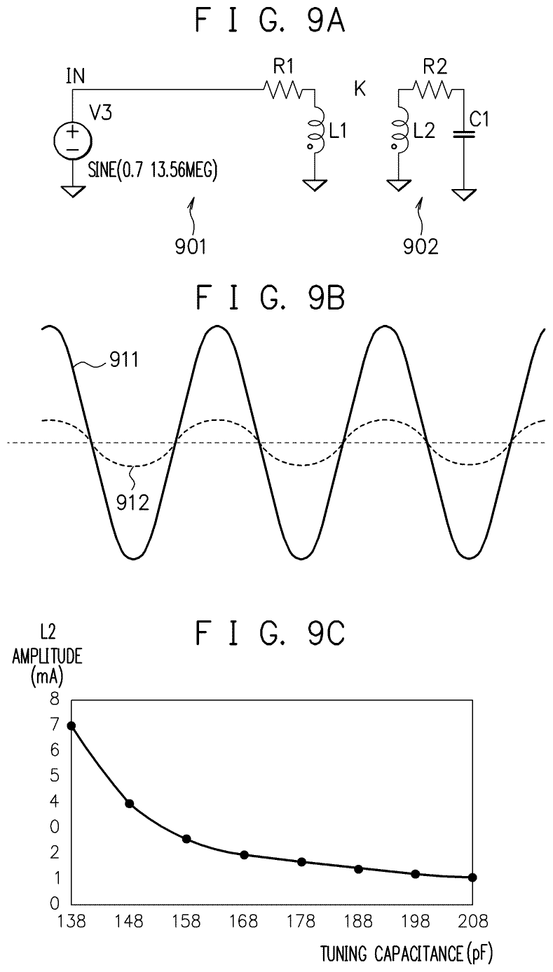

With reference to FIG. 9A to FIG. 9C, the following explains how it is possible to cause the adjacent loop antenna to generate a signal having the same phase as the transmission signal (modulated wave) supplied to the target loop antenna by tuning the resonance frequency to a frequency lower than that of the carrier signal (carrier wave).

FIG. 9A is a diagram illustrating an example of an electrical circuit model of a communication-target loop antenna 901 and an adjacent loop antenna 902. L1 represents an inductance associated with the target loop antenna, and R1 represents a series resistance associated with the target loop antenna. V3 represents an oscillation source of a carrier signal (carrier). L2 represents an inductance associated with the adjacent loop antenna, and R2 represents a series resistance associated with the adjacent loop antenna. C1 represents a capacitance used to form a series resonant circuit associated with the adjacent loop antenna. K is a coupling coefficient between the inductance L1 and the inductance L2.

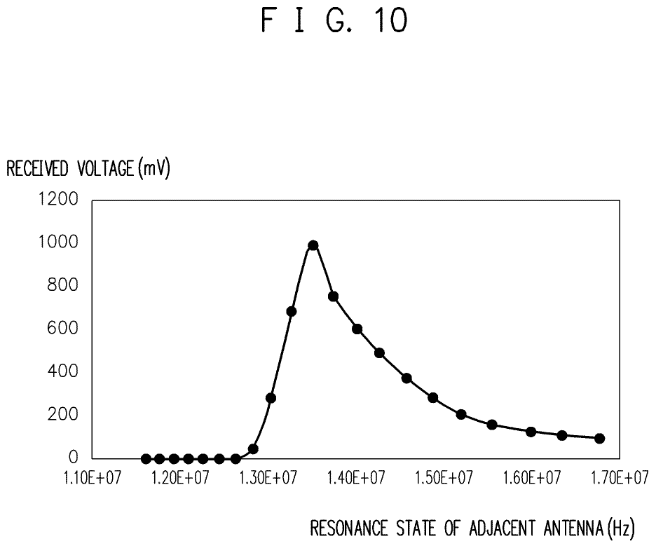

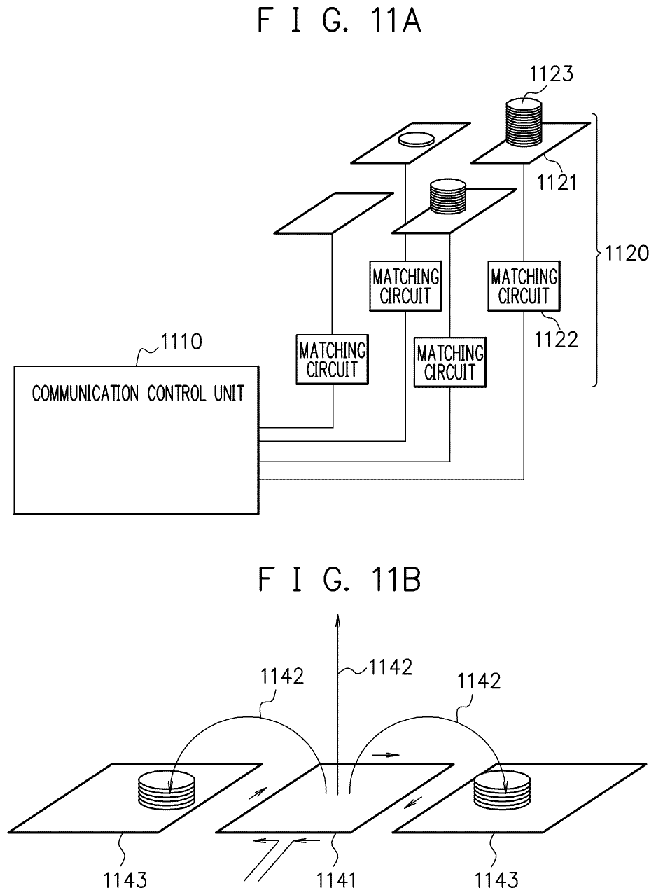

A simulation was performed with the frequency of the carrier signal (carrier) generated by the oscillation source V3 (carrier frequency) being 13.56 Mhz, the inductances L1, L2 being 1×10⁻⁶ H, the coupling coefficient K of the inductances L1, L2 being (−0.1), the resistances R1, R2 being 1 ohm, and the initial value of the capacitance C1 being 138 pF (the resonant circuit was tuned to the carrier frequency). As a result, by increasing the capacitance C1 and adjusting the resonance frequency of the adjacent loop antenna 902 to be lower than the frequency of the carrier signal (carrier wave), it was confirmed that the adjacent loop antenna generated a signal 912 of the same phase as a signal 911 supplied to the target loop antenna, as illustrated in the example of FIG. 9B. FIG. 9B is a schematic diagram illustrating signal waveforms at the target loop antenna and the adjacent loop antenna. The level adjustment as illustrated in FIG. 9C is possible by changing the value of the capacitance C1. FIG. 9C is a diagram illustrating the relation between values of the capacitance C1 and the current flowing in the inductance L2. As illustrated in FIG. 9C, increasing the value of the capacitance C1 (lowering the resonance frequency) may result in a smaller current in the inductance L2. That is, increasing the value of the capacitance C1 (lowering the resonance frequency) results in a smaller composite magnetic field of the leakage magnetic field from the target loop antenna and the adjacent loop antenna. Thus, the magnetic field supplied to the wireless tag arranged for the adjacent loop antenna is reduced, and unintended reading can be prevented. For example, as seen in the example of FIG. 10, as the resonance frequency (tuning frequency) of the adjacent loop antenna is lowered below 13.56 MHz as the frequency of the carrier signal (carrier wave), the voltage obtained for operating the wireless tag decreases to be very low around 12.6 MHz.

The reader/writer 600 illustrated in FIG. 6 includes the unintended-reading prevention circuits 621 for the respective loop antennas 221, such that the LCR circuit can be formed for the respective loop antennas 221.

The reader/writer 600 is configured to select, as a communication-target loop antenna, a loop antenna 221 for which a wireless tag 230 for reading and writing data is arranged, control the switches 703, 704 of the unintended-reading prevention circuit 621 such that the selected loop antenna 221 is connected to the matching circuit 222, and perform the reading and writing of data to the wireless tag 230 arranged for the selected loop antenna 221. At this time, the reader/writer 600 is configured to control the switches 703, 704 of the unintended-reading prevention circuit 621 corresponding to a non-selected loop antenna 221 such that the non-selected loop antenna 221 is connected to the serial circuit of the capacitance 701 and the resistor 702 included in the unintended-reading prevention circuit 621, and is configured to control the circuit including the loop antenna 221 and the capacitance 701 to be tuned to a frequency appropriately set lower than the frequency of the carrier signal (carrier wave).

Specifically, in an example where the loop antenna 221A is selected as the target loop antenna, the unintended-reading prevention circuits 621B, 621C, 621D are controlled such that the non-target loop antennas 221B, 221C, 221D are tuned to a frequency lower than the frequency of the carrier signal (carrier wave). In an example where the loop antenna 221B is selected as the target loop antenna, the unintended-reading prevention circuits 621A, 621C, 621D are controlled such that the non-target loop antennas 221A, 221C, 221D are tuned to a frequency lower than the frequency of the carrier signal (carrier wave). The same applies when the loop antenna 221C or 221D is selected as the target loop antenna.

Thus, with the reader/writer 600 in the second embodiment, a loop antenna adjacent to a communication-target loop antenna can generate a magnetic field for negating a leakage magnetic field leaking from the target loop antenna to the adjacent loop antenna, and thus unintended reading of a wireless tag arranged for the adjacent loop antenna can be prevented. Even if the intensity of the magnetic field output by the target loop antenna is increased, the adjacent loop antenna can negate the leakage magnetic field from the target loop antenna. Thus, the unintended reading of the wireless tag arranged for the adjacent loop antenna can be prevented while it is possible to read many wireless tags in parallel.

The above-described embodiments are merely examples of specific implementations for carrying out the present invention, and the technical scope of the present invention should not be construed as being limited by these embodiments. That is, the present invention can be implemented in various forms without departing from its technical concept or main characteristics.

What is claimed is:

1. A communication apparatus configured to communicate with a wireless tag, comprising:
a plurality of loop antennas, each of the loop antennas being configured to output a magnetic field corresponding to a transmission signal relating to the communication with the wireless tag to independently communicate with the wireless tag;
a communication control unit configured to output the transmission signal to a communication-target loop antenna among the plurality of loop antennas; and
a control unit configured to control a non-target loop antenna different from the communication-target loop antenna to generate a magnetic field for negating a magnetic field leaking from the communication-target loop antenna.

2. The communication apparatus of claim 1, wherein the control unit is configured to control the non-target loop antenna to generate a magnetic field in a direction opposite to a magnetic field outside the communication-target loop antenna.

3. The communication apparatus of claim 1, wherein the control unit includes a capacitance configured to be connected to the non-target loop antenna, and
the control unit is configured to tune a resonance frequency of a circuit including the loop antenna and the capacitance that are connected to each other to a frequency different from a carrier frequency of the transmission signal.

4. The communication apparatus of claim 3, wherein the control unit is configured to tune the resonance frequency of a circuit including the loop antenna and the capacitance that are connected each other to a frequency lower than the carrier frequency of the transmission signal.

5. The communication apparatus of claim 3, wherein the control unit includes a switch configured to connect the communication control unit to the communication-target loop antenna and connect the capacitance to the non-target loop antenna.

6. The communication apparatus of claim 1, wherein the control unit is configured to output, to the non-target loop antenna, a signal of a same phase as a phase of the transmission signal output to the communication-target loop antenna.

7. The communication apparatus of claim 6, wherein the control unit is configured to output, to the non-target loop antenna, the transmission signal having a level adjusted depending on an intensity of the magnetic field from the communication-target loop antenna.

8. The communication apparatus of claim 6, wherein the control unit is configured to output, to the non-target loop antenna, the transmission signal having a current level attenuated depending on an intensity of the magnetic field from the communication-target loop antenna.

9. The communication apparatus of claim 6, wherein the control unit is configured to output, to the non-target loop antenna, a carrier wave of the transmission signal having a level adjusted depending on an intensity of the magnetic field from the communication-target loop antenna.

10. A control method of a communication apparatus including a plurality of loop antennas, each of the loop antennas being configured to output a magnetic field corresponding to a transmission signal relating to communication with a wireless tag to independently communicate with the wireless tag, the control method comprising:
outputting the transmission signal to a communication-target loop antenna among the plurality of loop antennas; and
controlling a non-target loop antenna different from the communication-target loop antenna to generate a magnetic field for negating a magnetic field leaking from the communication-target loop antenna.
